(19) United States
(12) Patent Application Publication
(10) Pub. No.: US 2018/0141798 A1
(43) Pub. Date: May 24, 2018

(54) VARIABLE-FLOW BEER FAUCET

(71) Applicant: John J Spilotro, Tucson, AZ (US)

(72) Inventor: John J Spilotro, Tucson, AZ (US)

(21) Appl. No.: 15/806,783

(22) Filed: Nov. 8, 2017

Related U.S. Application Data
(60) Provisional application No. 62/424,281, filed on Nov. 18, 2016.

(51) Int. Cl. B67D 1/00; B67D 1/08

(52) U.S. Cl. CPC B67D 1/0085; B67D 1/0005; B67D 2001/0094; B67D 1/0888; B67D 2001/0089; B67D 1/0857

(57) ABSTRACT

A variable-flow beer faucet mechanism includes a housing including a flow-through valve, a beer inlet mechanism fluid coupled to the flow-through valve, a beer outlet mechanism fluid coupled to the flow-through valve, and a variable-flow activation handle coupled to the flow-through valve, the handle being mounted for limited rotational movement in 360 degrees with the amount of movement determining the flow.

### CROSS-REFERENCE TO RELATED APPLICATIONS

This application claims the benefit of U.S. Provisional Patent Application No. 62/424,281, filed 18 Nov. 2016.

### FIELD OF THE INVENTION

This invention relates to variable-flow beer faucets and the valve that provides the variable action.

### BACKGROUND OF THE INVENTION

Beer faucets, sometimes referred to as beer taps, are used in conjunction with stored sources of beer, such as kegs and the like. The beer faucets are fluid coupled to a beer source and retain the beer in the source until operated to draw some of the beer from the source into individual containers, such as glasses, steins, etc.

One problem that arises is that generally the beer flow rate from the faucet must be adjusted for each different beer types to minimize beer foam. Generally, the beer source is maintained in a cool environment (i.e. refrigerated) while the externally mounted beer faucet is open to room temperature or the surrounding temperature. Thus, at least the initial beer drawn can be warmed substantially and cause foam. Further, if the beer is consumed over a relatively long period, that is a relatively long period occurs between the drawing of glasses of beer, the temperature of each glass of beer can be raised several degrees,

It would be highly advantageous, therefore, to remedy this and other deficiencies inherent in the prior art.

Accordingly, it is an object of the present invention to provide a new and improved variable-flow beer faucet.

It is another object of the present invention to provide a new and improved horizontal orientated side handle operated valve that enables the user handle-throttle control of the beer flow velocity to minimize foam.

It is another object of the present invention to provide an automatic, battery power operated, beer dispensing valve that essentially re-purposes existing commercial plumbing technology used for automatic flushing of plumbing fixtures.

It is another object of the present invention to provide a new and improved beer faucet that is cooled internally.

It is another object of the present invention to provide a new and improved beer faucet that is easy and efficient to operate by moving the handle in any direction.

### SUMMARY OF THE INVENTION

The desired objects of the instant invention are achieved in accordance with a variable-flow beer faucet mechanism comprising a housing including a flow-through valve, a beer inlet mechanism fluid coupled to the flow-through valve, a beer outlet mechanism fluid coupled to the flow-through valve, and a variable-flow activation handle coupled to the flow-through valve, the handle being mounted for limited rotational movement in 360 degrees with the amount of movement determining the flow.

The desired objects of the instant invention are also achieved in accordance with a specific structure comprising a housing including a flow-through valve, a beer inlet mechanism, a beer inlet mechanism, and a variable-flow activation handle. The flow-through valve includes an elongated cylindrically shaped valve body having a central opening extending through the entire length with an outer diameter, an elongated poppet positioned within the central opening with limited longitudinal movement, a portion of the poppet having an outer diameter slightly smaller than the inner diameter of the central opening to guide longitudinal movements within the central opening, and a portion of the poppet having an enlarged outer diameter greater than the inner diameter of the central opening and operating in conjunction with a surface of the valve body as a flow valve, and a compression spring mounted to bias the enlarged outer diameter portion of the poppet against the surface of the valve body to stop flow through the valve body in an unused or normal orientation. The beer inlet mechanism is fluid coupled to the central opening in the valve body on one side of the surface of the valve body and the beer outlet mechanism is fluid coupled to the central opening in the valve body on a side opposite the one side of the surface of the valve body. The variable-flow activation handle includes a longitudinally extending bearing element attached to the housing, an elongated plunger mounted in the bearing element for longitudinal movement and having a first end and a second end, the plunger having an open position in which the first end buts against one end of the poppet so as to move the enlarged outer diameter portion of the poppet away from the surface of the valve body to allow flow through the valve body and a closed position in which the first end of the plunger is disengaged from the poppet so the enlarged outer diameter portion of the poppet is biased into engagement with the surface of the valve body and flow is stopped. A handle element is mounted for limited rotational movement in 360 degrees and positioned so that a portion buts against the second end of the elongated plunger. The handle element is further mounted so that rotational movement of the handle element moves the plunger from the closed position toward the open position to allow flow, the flow being variable in accordance with the amount of movement of the handle element and a spring biases the plunger into the closed position.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a view in perspective of a variable-flow beer faucet in accordance with the present invention;

FIG. 2 is a sectional view of the beer faucet of FIG. 1 as seen from the line 2-2 in FIG. 1;

FIG. 3 is a sectional view of the beer faucet of FIG. 1 as seen from the line 3-3 in FIG. 1;

FIG. 4 is a sectional view of the beer faucet of FIG. 1 as seen from the line 4-4 in FIG. 1;

FIG. 5 is a view in perspective of an example of the beer faucet of FIG. 1 in a typical usage installation for a Jockey Box;

FIG. 6 is a view in perspective of an example of the beer faucet of FIG. 1 in a typical usage installation for retrofit to existing Kegerators;

FIG. 7 is a view in perspective of an example of the beer faucet of FIG. 1 in a typical usage installation for a Picnic Keg;

FIG. 8 is a view in perspective of an example of the battery powered automated beer faucet of FIG. 1 by re-purposing existing commercial plumbing flushometer side handle operators for a picnic keg; and

FIGS. 9A, 9B, and 9C are views in perspective of examples of the beer faucets of FIG. 1 in typical usage installations for portable keg bars for large events such as golf outings.

### DETAILED DESCRIPTION OF THE DRAWINGS

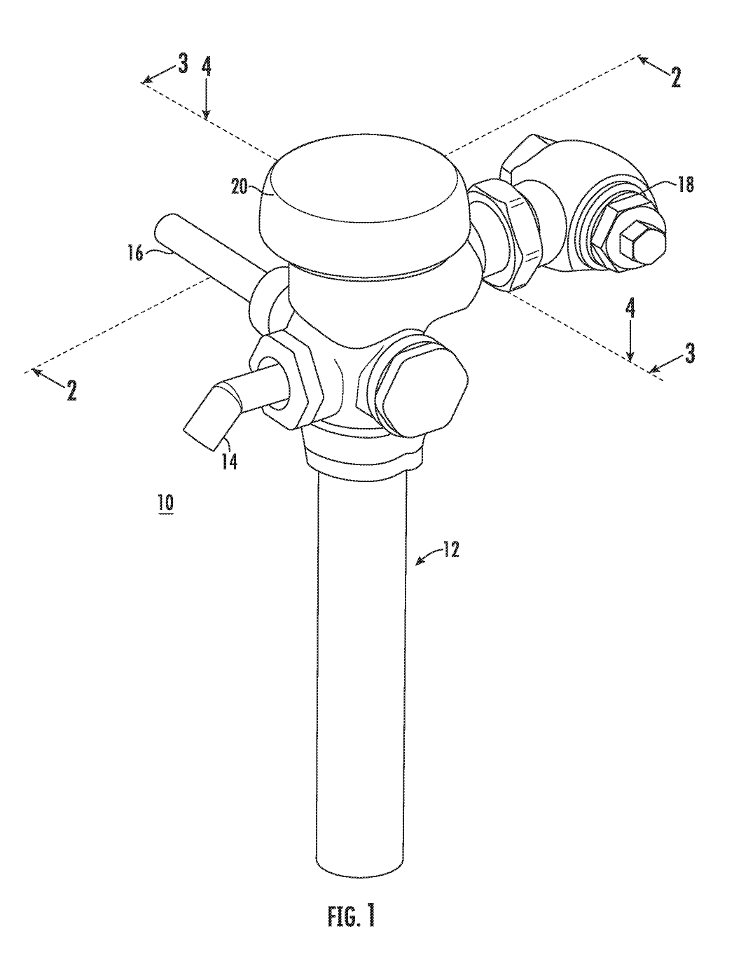

Turning to the drawings and specifically to FIG. 1, a variable-flow beer faucet 10 is illustrated as an example of the present invention. Faucet 10 includes a beer inlet mechanism 12, a beer outlet or nozzle 14, and a variable-flow activation handle 16. Activation handle 16 operates with a valve 30 to provide the desired variable-flow. Faucet 10, in this example, also includes an optional inlet/outlet mechanism 18 for the flow through of alternate or additional cooling fluid, such as a cool water or air flow. Faucet 10 further includes an upper cap or reservoir 20 that serves as a reservoir for cooling fluids.

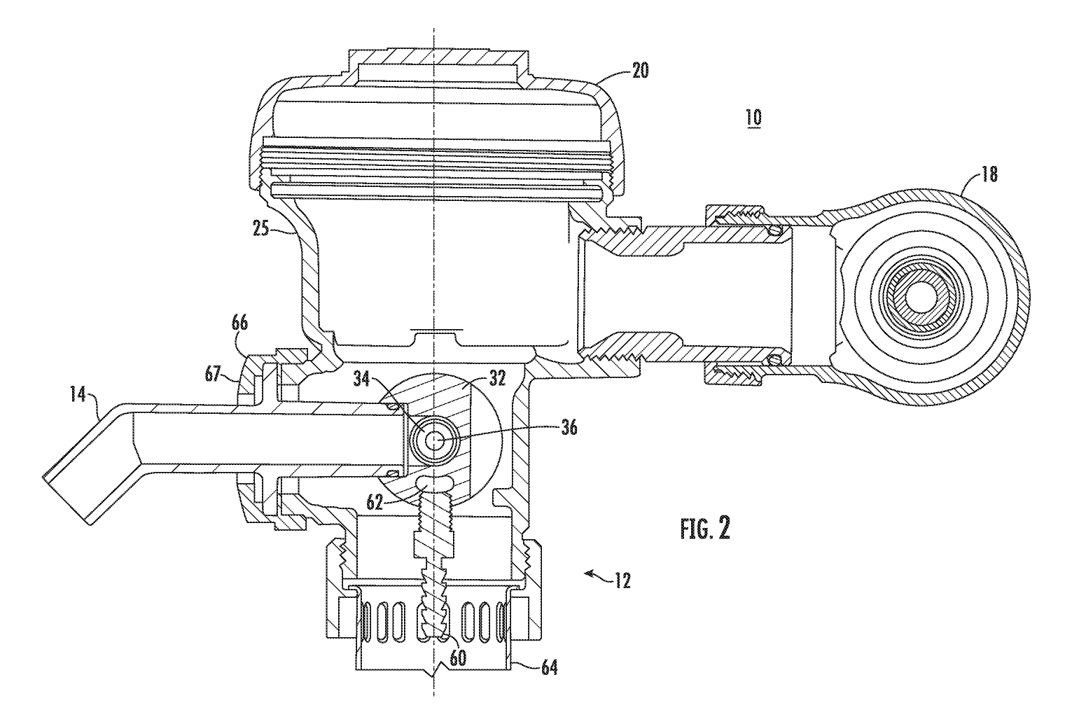

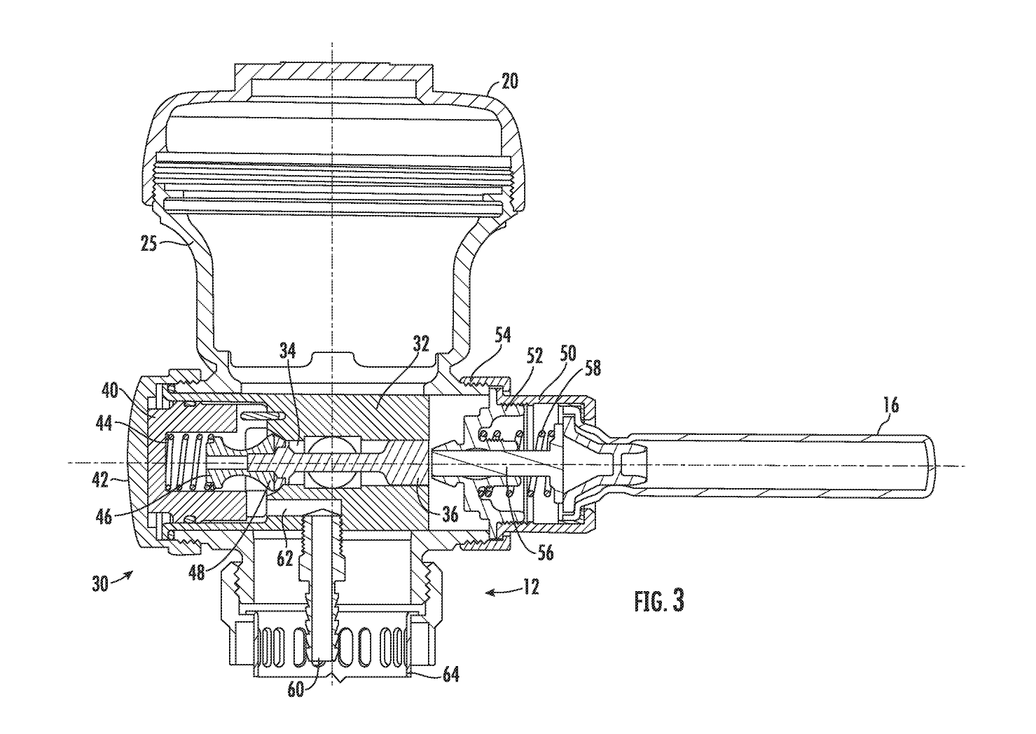

A complete description of valve 30 can be seen by comparing the views in the sectional views of FIGS. 2, 3, and 4. A housing or casting 25 provides support for the flow-through valve generally designated 30. Valve 30 includes an elongated cylindrically shaped valve body 32 that is inserted into housing 25 through an opening in the left-hand side as seen from FIG. 3. Valve body 32 has a central opening 34 extending through the entire length from one end to the other. An elongated poppet 36 is positioned within central opening 34 for limited longitudinal movement. As seen in FIG. 2, the right hand portion of poppet 36 has an outer diameter slightly smaller than the inner diameter of central opening 34 to hold poppet 36 coaxially within central opening 34 and to guide its longitudinal movements within central opening 34. A left-hand portion of valve body 32 is formed into a cup-shaped internal opening having an insert 40 slideably engaged therein and held in place by a cap 42 threadedly engaged over the opening in housing 25. Insert 40 has a central depression formed therein with a compression spring 44 positioned therein and a thimble-shaped element 46 positioned between compression spring 44 and the right hand-end of poppet 36 so as to bias poppet 36 to the right in FIG. 2.

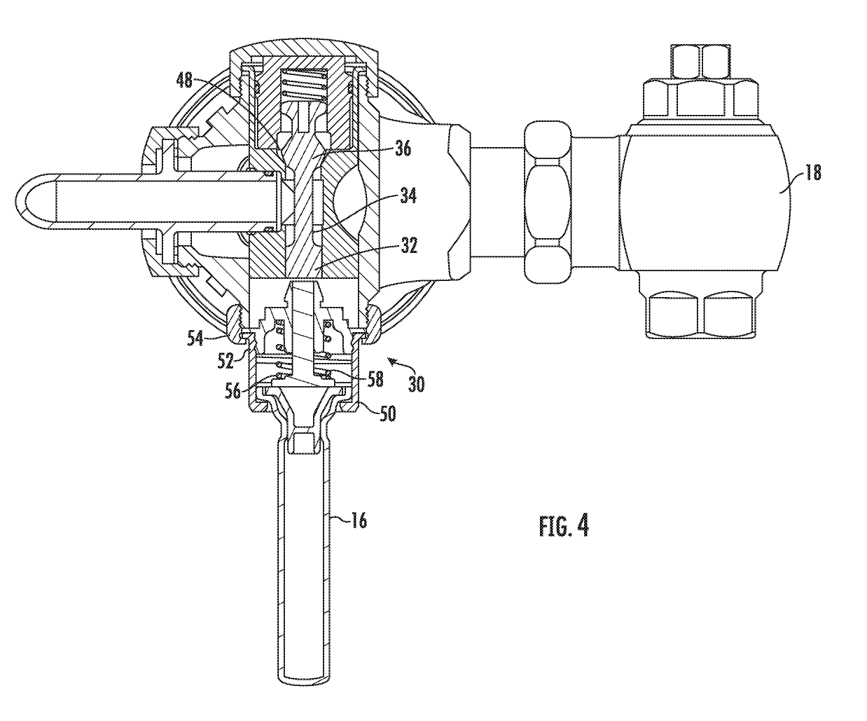

A portion 48 of poppet 36 adjacent the left-hand end (upper end in FIG. 4) is positioned within the cup-shaped internal opening in valve body 32 and has an enlarged outer diameter which is greater than the inner diameter of central opening 34. With poppet 36 biased into its extreme right-hand position a surface of portion 48 bears against a surface of valve body 32 to operate as a flow valve. With poppet 36 positioned in the extreme right-hand position (illustrated in FIGS. 3 and 4), fluid flow through valve 30 is stopped. When poppet 36 is moved to the left in FIG. 3 (up in FIG. 4), the surface of portion 48 is no longer in contact with the surface of valve body 32 and a passage for the flow of fluid through valve 30 is opened.

Variable-flow activation handle 16 is positioned in an opening in housing 25 directly opposite the opening positioning valve body 32. A cup-shaped mounting structure 50 is assembled over the opening and includes a central opening with handle 16 positioned therein for limited rotational movement in 360 degrees (i.e. up, down, right, left). A bearing element 52 extends across the open end of cup-shaped mounting structure 50 and both cup-shaped mounting structure 50 and bearing element 52 are held in place by a threaded ring 54 threadedly engaged on housing 25. An elongate plunger 56 is mounted in bearing element 52 for longitudinal movement. Plunger 56 is positioned so that one end buts against an inner surface of handle 16 and the opposite end is positioned adjacent the right-hand end (in FIG. 3) of poppet 34. A compression spring 58 is positioned coaxially around plunger 56 and between bearing element 52 and a surface of plunger 56 so as to bias plunger 56 into the right hand position illustrated in FIGS. 3 and 4. When handle 16 is rotated or moved in any direction plunger 56 is forced to the left and engages the end of poppet 36, thereby forcing poppet 36 to the right and opening valve 30.

Inlet mechanism 12 includes a tubular barbed fitting (or quick push-connect fitting) 60 that is threadedly engaged in an inlet opening in valve body 32. Fitting 60 is barbed along the outer surface adjacent the lower end so as to receive a hose (rubber, plastic, etc.) in fluid communication therewith, which hose is further coupled to a fluid supply under pressure, e.g. a beer keg or the like. The internal opening through fitting 60 is in fluid communication with central opening 34 in valve body 32 by means of a longitudinally extending fluid passage 62 formed in valve body 32.

Inlet mechanism 12 also includes an elongated cylindrical tube 64 that is attached at one end to and extends downwardly from housing 25 coaxially around fitting 60. The opposite end of tube 64 (not illustrated) is available to be attached in communication with a source of cool liquid (e.g. water, air, etc.). Here it should be specifically noted that any cool liquid flowing in tube 64 can flow freely around fitting 60 and valve 30 into reservoir 20 and out (or in) optional inlet/outlet mechanism 18. If optional inlet/outlet mechanism 18 is not present the opening in housing 25 can be capped or otherwise closed and the fluid flowing into tube 64 will substantially completely surround valve 30 so as to maintain fluid flowing or held within valve 30 at a constant temperature.

Beer outlet or nozzle 14 is mounted in an opening in housing 25 by means of a radially outwardly extending flange 66 held against housing 25 by a cap 67 threadedly engaged over nozzle 14 and flange 66 and the opening in housing 25. Nozzle 14 is fluid coupled to an opening in the side of valve body 32 which communicates with the longitudinal opening in the center of valve body 32. Thus, when handle 16 is rotated or moved in any direction, plunger 56 is forced to the left and engages the end of poppet 36, thereby forcing poppet 36 to the right and opening valve 30 so that fluid is free to flow through the longitudinal opening in the center of valve body 32 from fitting 60 and out nozzle 14.

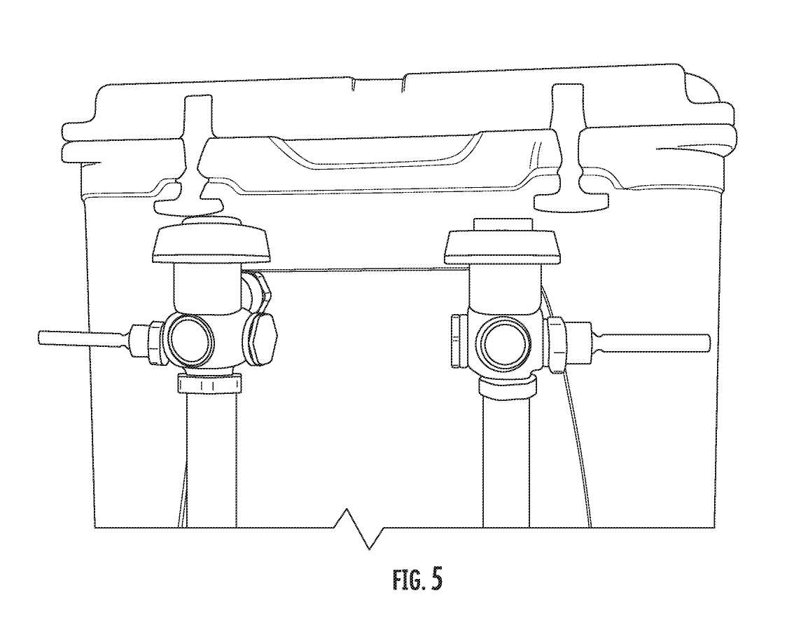

Turning to FIG. 5, two examples of beer faucet 10 are illustrated mounted on A Yeti cooler. In this example of a typical use for beer faucet 10, a source of beer is contained within the Yeti cooler as well as a source of cool water. A hose (not shown) is attached between a source of beer in the Yeti cooler and fitting 60 so as to supply beer to either or both of the illustrated valves 30. Also, tubes 64 of the illustrated valves 30 are bent to provide fluid communication with cool water inside of the Yeti cooler. In this example, optional inlet/outlet mechanism 18 is not included.

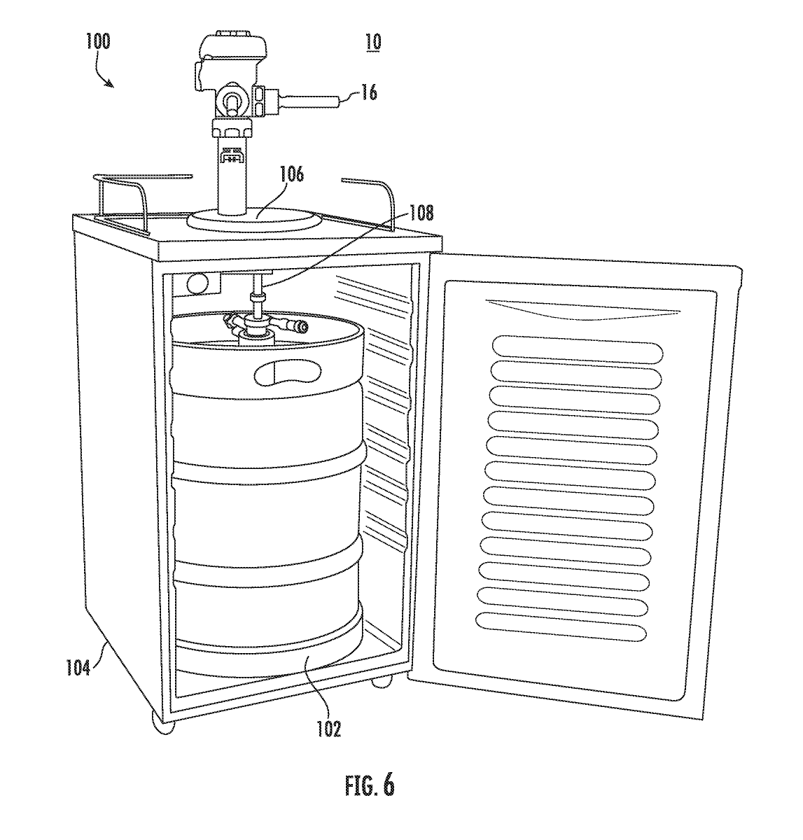

Turning to FIG. 6, a standard Kegerator beer tower 100 is illustrated including a keg of beer 102 positioned in a cooler 104, all of which is well known in the art. In this example, elongated cylindrical tube 64 of beer faucet 10 is mounted/attached at the lower end to an opening 106 in the upper wall of cooler 104 so as to rigidly mount beer faucet 10 in an upwardly directed orientation over beer tower 100. A flexible hose 108 extends through cylindrical tube 64 and is attached at one end to fitting 60 of beer faucet 10 and at the other end is connected in fluid communication with keg 102. In this example, cool air is free to flow from cooler 104 into beer faucet 10. As explained in detail above, and beer flow is controlled by variable-flow activation handle 16.

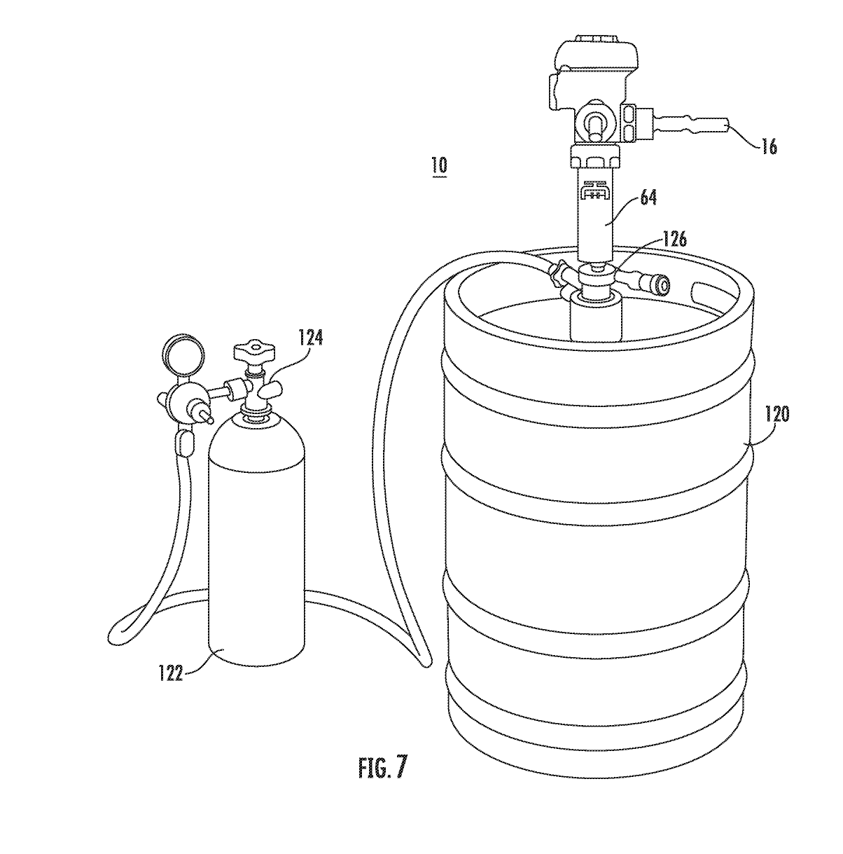

Turning now to FIG. 7, a typical usage installation of beer faucet 10 is illustrated for a picnic Keg 120. In this example a standard source of CO₂ or gas pressure is connected to keg 120 by means of a standard pressure valve 124 and keg fitting 126. In this example, elongated cylindrical tube 64 of beer faucet 10 is mounted/attached at the lower end to keg fitting 126 so as to rigidly mount beer faucet 10 in an upwardly directed orientation over keg 120. A flexible hose (not illustrated) extends through cylindrical tube 64 and is attached at one end to fitting 60 of beer faucet 10 and at the other end is connected in fluid communication with keg 102. Beer flow is controlled by variable-flow activation handle 16.

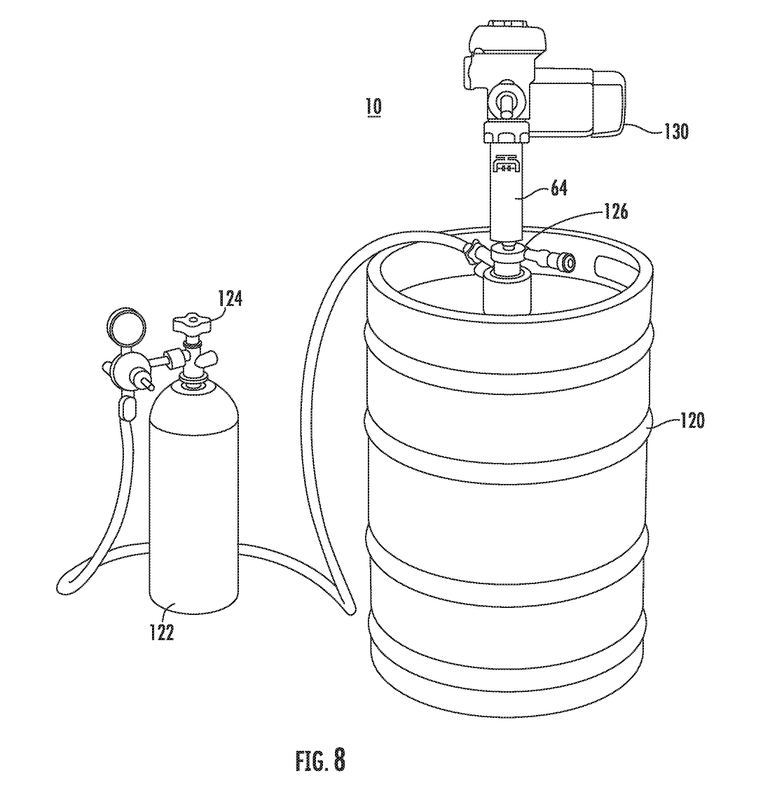

Referring additionally to FIG. 8, beer faucet 10 is illustrated operationally attached to a Picnic Keg 120, as illustrated in FIG. 7. In this example, variable-flow activation handle 16 is replaced with a sensor/remote command, battery powered, volume controlled dispensing system 130.

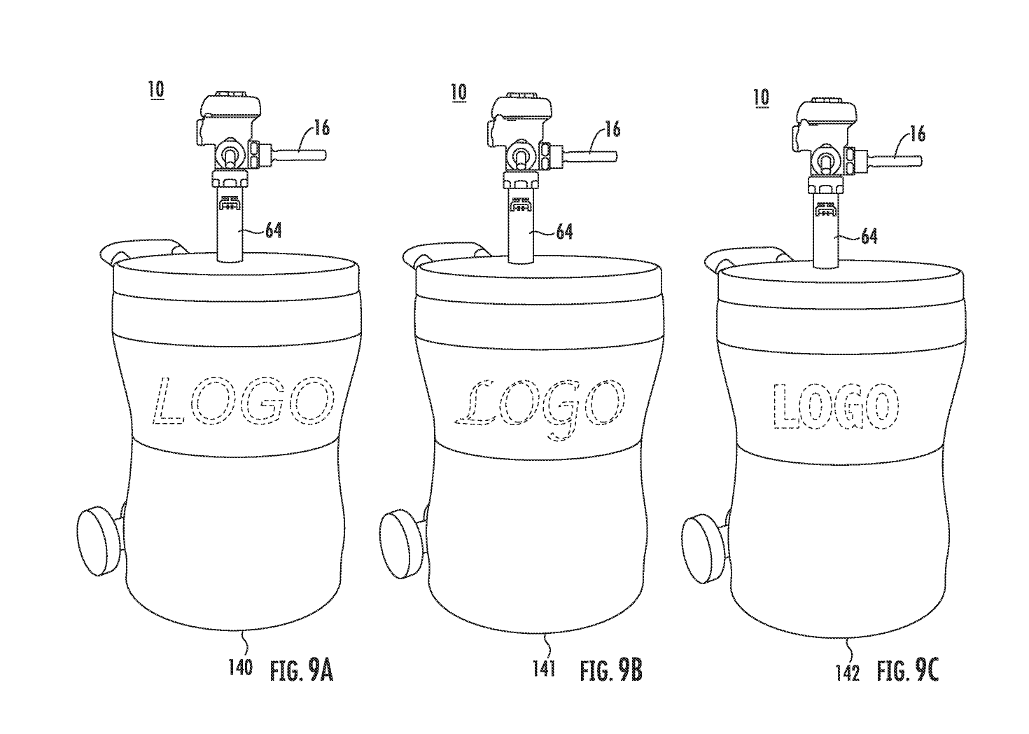

Referring additionally to FIGS. 9A, 9B, and 9C typical usage installations of beer faucet 10 are illustrated for several portable beer kegs 140, 141, and 142, respectively. In each of these examples, elongated cylindrical tube 64 of beer faucet 10 is mounted/attached at the lower end to the beer outlet of the kegs so as to rigidly mount beer faucet 10 in an upwardly directed orientation over the beer kegs. A flexible hose (not illustrated) extends through cylindrical tube 64 and is attached at one end to fitting 60 of beer faucet 10 and at the other end is connected in fluid communication with the keg 140, 141, and 142, respectively. In each example, beer flow is controlled by variable-flow activation handle 16.

Thus, the present invention discloses and provides a new and improved beer faucet and further, a new and improved beer faucet that is cooled internally. The new and improved beer faucet includes a horizontally orientated side handle operated valve that enables the user handle-throttle control of the beer flow velocity to minimize foam and is operated by moving the handle in any direction. Also, an automatic, battery power operated, beer dispensing valve may be substituted for the variable-flow activation handle, essentially re-purposing existing commercial plumbing technology used for automatic flushing of plumbing fixtures. The new and improved beer faucet is also easy and efficient to operate.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A variable-flow beer faucet mechanism comprising:
a housing including a flow-through valve;
a beer inlet mechanism fluid coupled to the flow-through valve;
a beer outlet mechanism fluid coupled to the flow-through valve; and
a variable-flow activation handle coupled to the flow-through valve, the handle being mounted for limited rotational movement in 360 degrees with the amount of movement determining the flow.

2. The variable-flow beer faucet mechanism as claimed in claim 1 wherein the flow-through valve includes an elongated cylindrically shaped valve body having a central opening extending through the entire length with an outer diameter, an elongated poppet positioned within the central opening with limited longitudinal movement, a portion of the poppet having an outer diameter slightly smaller than the inner diameter of the central opening to guide longitudinal movements within the central opening, and a portion of the poppet having an enlarged outer diameter greater than the inner diameter of the central opening and operating in conjunction with a surface of the valve body as a flow valve, and a compression spring mounted to bias the enlarged outer diameter portion of the poppet against the surface of the valve body to stop flow through the valve body in an unused or normal orientation.

3. The variable-flow beer faucet mechanism as claimed in claim 2 wherein the beer inlet mechanism is fluid coupled to the central opening in the valve body on one side of the surface of the valve body.

4. The variable-flow beer faucet mechanism as claimed in claim 3 wherein the beer inlet mechanism includes a tubular barbed fitting engaged in an inlet opening in the valve body, the fitting being barbed along the outer surface adjacent the lower end so as to receive a hose in fluid communication therewith, which hose being further coupled to a fluid supply under pressure.

5. The variable-flow beer faucet mechanism as claimed in claim 4 further including an inlet/outlet mechanism for the flow through of alternate or additional cooling fluid.

6. The variable-flow beer faucet mechanism as claimed in claim 5 wherein the inlet/outlet mechanism further includes an elongated cylindrical tube coaxially surrounding the tubular barbed fitting for cooling beer at the inlet/outlet mechanism and/or mounting the variable-flow beer faucet mechanism.

7. The variable-flow beer faucet mechanism as claimed in claim 3 wherein the beer outlet mechanism is fluid coupled to the central opening in the valve body on a side opposite the one side of the surface of the valve body.

8. The variable-flow beer faucet mechanism as claimed in claim 1 wherein the variable-flow activation handle includes:
a longitudinally extending bearing element attached to the housing;
an elongated plunger mounted in the bearing element for longitudinal movement and having a first end and a second end, the plunger having an open position in which the first end buts against one end of the poppet so as to move the enlarged outer diameter portion of the poppet away from the surface of the valve body to allow flow through the valve body and a closed position in which the first end of the plunger is disengaged from the poppet so the enlarged outer diameter portion of the poppet is biased into engagement with the surface of the valve body and flow is stopped;
a handle element mounted for limited rotational movement in 360 degrees and positioned so that a portion buts against the second end of the elongated plunger, the handle element being further mounted so that rotational movement of the handle element moves the plunger from the closed position toward the open position to allow flow, the flow being variable in accordance with the amount of movement of the handle element; and
a spring biasing the plunger into the closed position.

9. The variable-flow beer faucet mechanism as claimed in claim 1 further including an inlet/outlet mechanism attached to the housing for the flow through of alternate or additional cooling fluid.

10. The variable-flow beer faucet mechanism as claimed in claim 9 wherein the inlet/outlet mechanism further includes an upper cap attached to the housing and in communication with the inlet/outlet mechanism and operating as a reservoir for cooling fluids.

11. The variable-flow beer faucet mechanism as claimed in claim 1 further including a sensor/remote command, battery powered, volume controlled dispensing system.

12. A variable-flow beer faucet mechanism comprising:
a housing including a flow-through valve, the flow-through valve including:
an elongated cylindrically shaped valve body having a central opening extending through the entire length with an outer diameter;
an elongated poppet positioned within the central opening with limited longitudinal movement, a portion of the poppet having an outer diameter slightly smaller than the inner diameter of the central opening to guide longitudinal movements within the central opening, and a portion of the poppet having an enlarged outer diameter greater than the inner diameter of the central opening and operating in conjunction with a surface of the valve body as a flow valve;
a compression spring mounted to bias the enlarged outer diameter portion of the poppet against the surface of the valve body to stop flow through the valve body in an unused or normal orientation;
a beer inlet mechanism fluid coupled to the central opening in the valve body on one side of the surface of the valve body;
a beer outlet mechanism fluid coupled to the central opening in the valve body on a side opposite the one side of the surface of the valve body; and
a variable-flow activation handle including:
a longitudinally extending bearing element attached to the housing;
an elongated plunger mounted in the bearing element for longitudinal movement and having a first end and a second end, the plunger having an open position in which the first end buts against one end of the poppet so as to move the enlarged outer diameter portion of the poppet away from the surface of the valve body to allow flow through the valve body and a closed position in which the first end of the plunger is disengaged from the poppet so the enlarged outer diameter portion of the poppet is biased into engagement with the surface of the valve body and flow is stopped;
a handle element mounted for limited rotational movement in 360 degrees and positioned so that a portion buts against the second end of the elongated plunger, the handle element being further mounted so that rotational movement of the handle element moves the plunger from the closed position toward the open position to allow flow, the flow being variable in accordance with the amount of movement of the handle element; and
a spring biasing the plunger into the closed position.

13. The variable-flow beer faucet mechanism as claimed in claim 12 wherein the beer inlet mechanism includes a tubular barbed fitting engaged in an inlet opening in the valve body, the fitting being barbed along the outer surface adjacent the lower end so as to receive a hose in fluid communication therewith, which hose being further coupled to a fluid supply under pressure.

14. The variable-flow beer faucet mechanism as claimed in claim 13 further including an inlet/outlet mechanism attached to the housing for the flow through of alternate or additional cooling fluid.

15. The variable-flow beer faucet mechanism as claimed in claim 14 wherein the inlet/outlet mechanism further includes an upper cap attached to the housing and in communication with the inlet/outlet mechanism and operating as a reservoir for cooling fluids.

16. The variable-flow beer faucet mechanism as claimed in claim 14 wherein the inlet/outlet mechanism further includes an elongated cylindrical tube coaxially surrounding the tubular barbed fitting for cooling beer at the inlet/outlet mechanism and/or mounting the variable-flow beer faucet mechanism.

17. The variable-flow beer faucet mechanism as claimed in claim 12 further including a sensor/remote command, battery powered, volume controlled dispensing system.
